(19) United States
(12) Patent Application Publication
(10) Pub. No.: US 2026/0170424 A1
(43) Pub. Date: Jun. 18, 2026

(54) SYSTEMS AND METHODS FOR AUTOMATION ROI TRACKING

(71) Applicant: WELLS FARGO BANK, N.A., San Francisco, CA (US)

(72) Inventors: Blaze Anthony Bryant, Asheville, NC (US); Javier Spina, New York, NY (US); Jesse Rawlings, Charlotte, NC (US)

(21) Appl. No.: 18/981,091

(22) Filed: Dec. 13, 2024

(51) Int. Cl. G06Q 10/0631; G06Q 30/0283

(52) U.S. Cl. CPC G06Q 10/0631; G06Q 30/0283

(57) ABSTRACT

Systems and methods for automation ROI tracking. The systems and methods include receiving a set of manual metrics corresponding to execution of a manual task and receiving a request to execute an automation software. A set of automation metrics corresponding to an execution of the automation software, and a set of comparison metrics based on comparing the set of manual metrics with the set of automation metrics are generated. The set of comparison metrics is then output.

### FIELD OF INVENTION

The present disclosure generally relates to tool automation analysis, and more specifically to systems and methods for evaluating the return on investment of implementing automation tools within a computing environment.

### BACKGROUND

Task automation such as robotic process automation (“RPA”) is a known technique for automating repetitive tasks. Increasingly, organizations have looked to task automation tools to provide for boosts in productivity and efficiencies within their computing systems and workflows. However, generating and implementing automated tools for executing task automation services can itself be an inefficient process. Automating every possible task which can be automated may not yield benefits to such organizations. In fact, automating tasks can lead to reductions in efficiencies within computing systems, for instance, in requiring resource expenditures to generate the automation tool, such resources being greater than the potential benefits of automation. Moreover, the quality of such automation tools may be inferior to prior executions of the previously unautomated tasks.

### SUMMARY

According to certain examples, a method for automation return on investment (“ROI”) tracking is described. The method includes receiving a set of manual metrics corresponding to execution of a manual task and receiving a request to execute an automation software. The method includes generating a set of automation metrics corresponding to an execution of the automation software and generating a set of comparison metrics based on comparing the set of manual metrics with the set of automation metrics. The method further includes outputting the set of comparison metrics.

Another example relates to a system including one or more processors configured to provide an automated ROI tracking analysis. The one or more processors are configured to perform operations including receiving a set of manual metrics corresponding to execution of a manual task and receiving a request to execute an automation software. The operations include generating a set of automation metrics corresponding to an execution of the automation software and generating a set of comparison metrics based on comparing the set of manual metrics with the set of automation metrics. The operations further include outputting the set of comparison metrics.

A further example relates to a non-transitory computer readable medium comprising instructions that, when executed by one or more processors, cause the one or more processors to provide an automated ROI tracking analysis. The instructions include causing the one or more processors to perform operations including receiving a set of manual metrics corresponding to execution of a manual task and receiving a request to execute an automation software. The operations include generating a set of automation metrics corresponding to an execution of the automation software and generating a set of comparison metrics based on comparing the set of manual metrics with the set of automation metrics. The operations further include outputting the set of comparison metrics.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

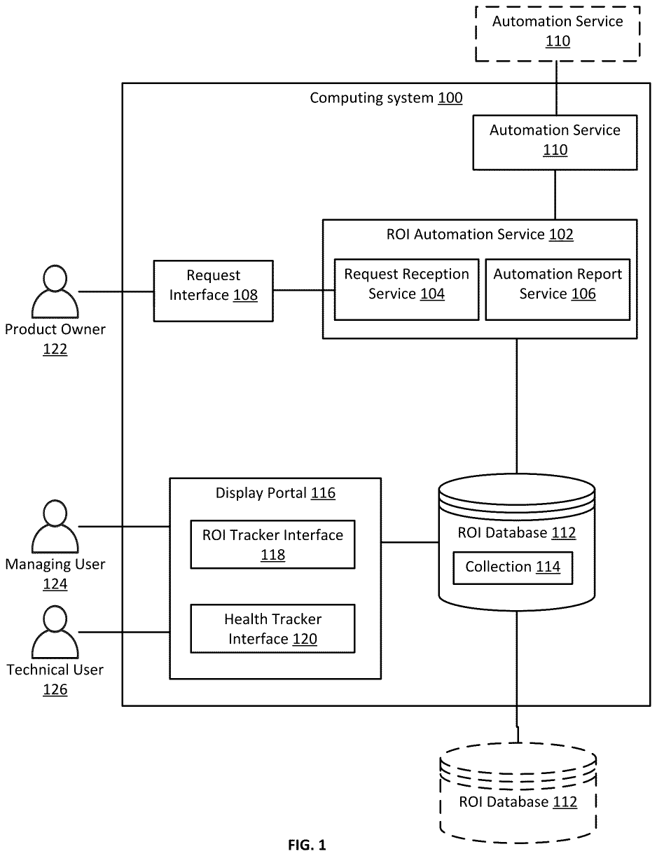

FIG. 1 shows a system for performing return on investment (“ROI”) analysis related to automating services, according to certain examples.

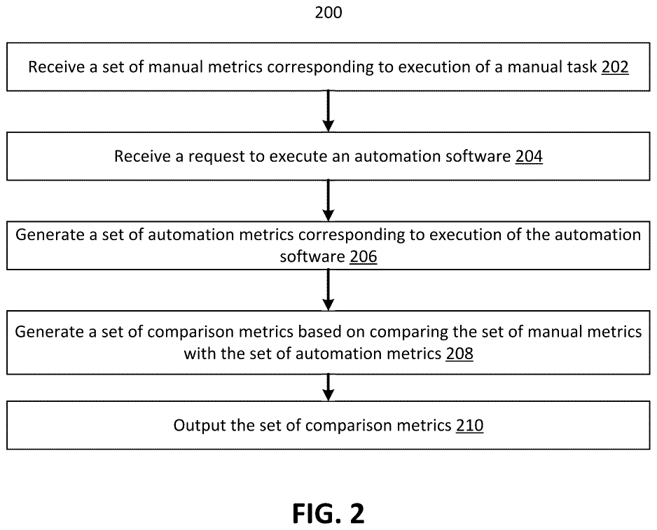

FIG. 2 shows an example process for automation ROI tracking, according to certain examples.

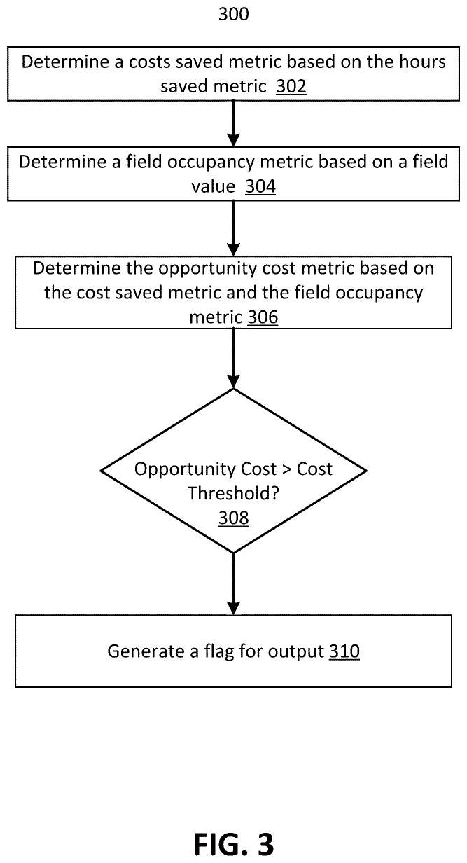

FIG. 3 shows an additional example process for automation ROI tracking, according to certain examples.

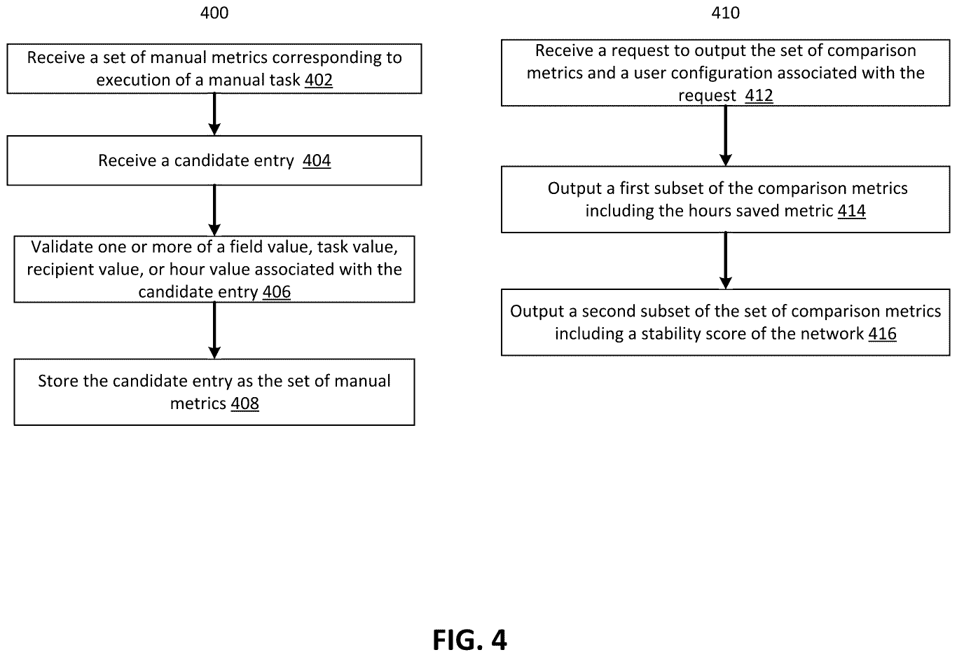

FIG. 4 shows example processes for interfacing with the automation ROI tracking system, according to certain examples.

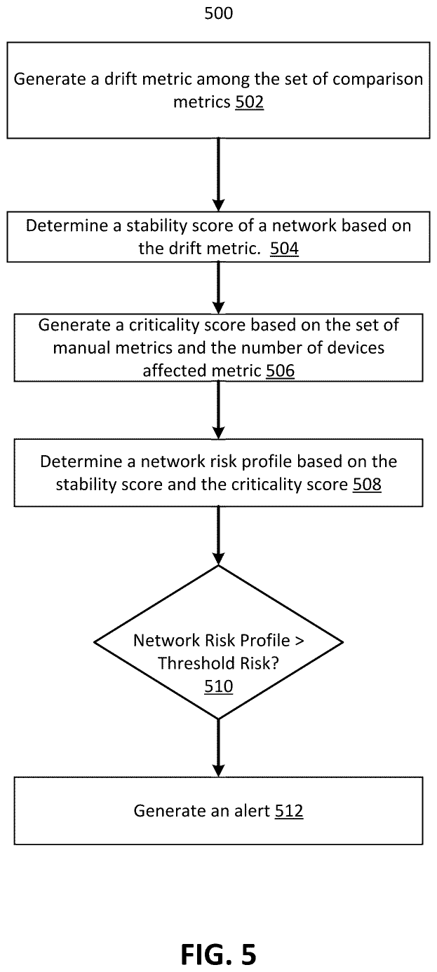

FIG. 5 shows example process for determining network stability within automation ROI tracking system, according to certain examples.

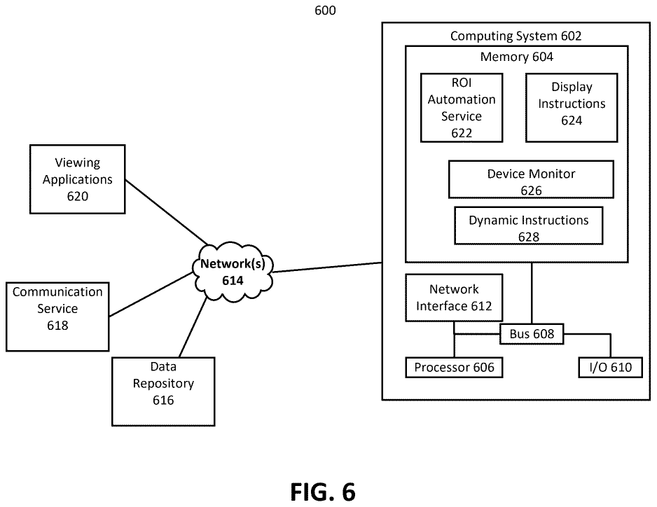

FIG. 6 shows a block diagram for an example computing environment capable of executing the described systems and methods, according to certain examples.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example of Automation ROI Tracking

In one illustrative example, an automation return on investment (“ROI”) tracking system is described, providing means for determining the comparative efficiencies of implementing various automation tools to replace former, manually performed and partially automated tasks. Architecture is described including systems, databases, schemas, code logic, and other components used to measure the effectiveness, efficiency, reliability, and value of automating workloads within multiple development areas. Through the described systems and methods, immediate and long-term benefits can be identified, including but not limited to the elimination and/or reduction of repetitive manual operations; improved risk profiles across different development areas; increased velocity of completed tasks; improved user experience; and increased infrastructure stability over corresponding networks.

The ROI tracking system can measure both tangible and intangible benefits of implementing an automated software to replace or augment execution of a preexisting manual or partially automated task. The costs of the automation software as a solution (i.e., licensing, subscription, maintenance and the like) can be determined and compared against the costs of manual execution of the task (e.g., hour expenditures and time lost in manually, repetitively executing the manual task). Components of return can include the cost savings resulting from the implementation of automated workflows in addition to completed higher-value work.

Tangible benefits evaluated can include, for instance, the number of manual hours reduced and saved by implementing the proposed software automation program. Similarly, costs as determined based on the number of hours can be determined and further recorded as an example of tangible benefits. Intangible benefits monitored can include determining the opportunity cost in leaving the task unautomated. For instance, based on the team associated with executing the manual task, and the expenditures of the team executing the manual task, higher value work (i.e., less easily automatable) can be identified and compared against the hour expenditures. In such a way, the opportunity cost can be analyzed and reported resulting in key resources instead being allocated to higher-value tasks thereby increasing delivery quality.

In another aspect, the automation ROI system can further monitor network stability as a component of ROI determinations. For instance, the manual tasks as candidates for automation can be monitored for metrics such as drift (i.e., the variance in separate execution of the manual task) along with the number of devices affected and the criticality of the task. Based on such monitoring, the automation ROI system can monitor, report, and prioritize tasks for execution based on associated improvements to network stability.

The automation ROI tracker can include several interfaces providing for input (e.g., input of manual metrics) and output (e.g., through display of the generated ROI analysis). The input interface can include webpages, applications, and other software providing for seamless interfacing with the automation ROI system. The interface can be enforced through extensible, flexible schema capable of ensuring that data is properly input for execution of the automation ROI system, while simultaneously allowing for variations of inputs to be entered to further the automation analysis.

Multiple output interfaces including different types of dashboards can be integrated to allow for various sets of users to analyze the benefits of implementing automation software across various environments and lines of business. For example, some dashboards and interfaces may be directed to project management teams where such dashboards and interfaces output generated metrics specifically associated with costs, hours spent, and other expenditures. Other dashboards and interfaces may be directed towards technical teams where such dashboards and interfaces report infrastructural stability improvements related to implementation of software automations.

The described automation ROI system, capable of receiving manual metrics, monitoring the execution of software automations, and generating and displaying ROI metrics thus allows a variety of users to determine the efficacy of implementing software automations across a variety of tasks. Such insights are particularly helpful in prioritizing and determining how to proceed within a broad scope of potential automation pursuits. Moreover, the automation ROI tracking system as described enables efficient prioritization and application of automation software critical for network stability, further enabling auto-resolution in preparation for self-healing networks.

### Example Computing System for Proportional Allocation

FIG. 1 illustrates a system for automation ROI tracking, according to certain examples. The examples according to FIG. 1 are shown to illustrate the logical and physical implementation of the automation ROI tracking system according to certain examples. Other embodiments, however, are possible. For instance, certain components may be shown as distinct components to illustrate the progression of the data flow, while according to some embodiments, the physical implementation of such components may be implemented across the same device. It is to be appreciated that the example embodiments according to FIG. 1 are provided for illustrative purposes. A computing system 100 is shown for performing automation ROI analysis. Examples of implementations of the computing system 100 capable of implementing the described embodiments of FIG. 1 are discussed further with respect to the computing system of FIG. 6.

The computing system 100 shows an automation ROI service 102 communicatively coupled to other interfaces including a request interface 108 and an automation service 110. The automation service 110 in some examples can comprise an application programming interface (“API”), also referred to as the FastAPI Micro-service. The ROI automation service 102 includes a request reception service 104 for receiving inputs via a request interface 108 and an automation report service 106 for generating collections, or reports providing analyses of metrics related to execution of a manual task compared to execution of an automated service capable of performing the manual task.

The request reception service 110 can interface with POST, PATCH, DELETE, and GET methods and endpoints used to create, delete, or retrieve metrics associated with manual execution of a task, also referred to as automation details document. In receiving and retrieving automation details documents, the request reception service 110 can also enforce schema to ensure that the automation details document, storing the metrics associated with manual execution of a task, are properly input and that necessary details for performing an automation ROI analysis are present.

The request reception service 110 retrieves the automation details documents via inputs to a request interface 108. The request interface 108 can provide means for users, such as product owners 122, to provide metrics associated with execution of a manual task. The request interface can for instance include a webpage, application, or other interface with form entries for creating updating, or deleting documents as stored in a collection 114. Users providing input through the request interface 108 can include product owners 122 or any other users who have insights as to the manual metrics for executing a task (e.g., estimated number of hours to execute the task, the number of workers assigned to the task and the like). Examples of inputs users can provide include data related to line of business, development team, development contact, customer team, customer regions, customer contacts, and manual hours referring to the hours that current manual or automated processes take to execute the task. Once the data has been entered, the user may select an option to create an intake artifact which formalizes the creation of the automation details document including the set of manual metrics.

The ROI automation service 102 also interfaces with an automation service 110, also referred to as automated software. The automation service 110 can be a preexisting tool capable of executing a task corresponding to the manual task for ROI analysis. The automation service 110 may be preexisting within the computing system 100 or within a network connected to the automation service 110. In other examples, the ROI automation service 102 can identify and retrieve an out-of-network automation service which can be a preexisting product identified as capable of executing an automation of the manual task.

Once the automation service 110 is executed, the ROI automation service 102 can record and track metrics and details corresponding to execution of the automation service. Transient values generated during each automation run of the automation service 102 may thus be recorded and logged per the ROI automation service 102, as stored as part of the collection 114. Each collection 114 may each represent a record for storing the various metrics associated with manual task, automation task pair including manual metrics, automated metrics, and the comparison metrics as generated by the automation service 102.

Data processed and analyzed by the ROI automation service 102, including the automation details document provided via the request interface 108, and the automation details recorded from execution of the automation service 110, may be stored as collection 114 in an ROI database 112. ROI database 112 can comprise any data repository structure capable of storing structured data files. In some examples, ROI database 112 is stored locally within the computing system 100. In other examples, ROI database 112 comprises a Network as a Service (NaaS) data repository external to the computing system 100 but communicatively coupled to the computing system 100. Examples of NaaS services for providing physical storage of the ROI database 112 can include MongoDB, PostgreSQL, CloudSQL, and the like.

Collections 114, generated by the ROI automation service 102 can be stored in the ROI database 112. Collections 114 store the details of the automation such as line of business, development, customer, and the like. Additionally, details describing the execution of the automation service 110 such as date and time the automation ran, success rate scores indicating success or failure of the automation, automation length and the like may similarly be stored as details within a given collection 114. Generally, all the details and metrics for analyzing and comparing execution of a manual task with a corresponding automation service may be stored as part of a given collection within the ROI database 112.

Various details and metrics as stored in the collection 114 may be retrieved and aggregated for display via a display portal 116 according to one or more interfaces such as ROI tracker interface 118 and health tracker interface 120. The different interfaces 118-120 may be chosen for display according to a user's role in software development and in project management. For instance, the ROI tracker interface 118 can provide dashboards and views of the collections 114 with provided emphasis on the costs savings analysis (e.g., hours spent in performing the manual task compared to an automation of the task) which may have particular relevance for a managing user 124 such as user within a project management position, while the health tracker interface 120 may have particular relevance for technical users 126 tasked with ensuring stability of the associated computing networks. Examples of interface software used to generate the visual interfaces 118-120 can include Power BI, Grafana, and the like.

The described users including product owner 122, managing user 124, and technical user 126 are described with respect to the computing system 100 for illustrative purposes only, indicating how different interfaces 108, 118, and 120 may be separately configured and built to accommodate a variety of tasks and purposes according to the described embodiments. Such users are non-limiting, and it is to be appreciated that different configurations of users may interface with the computing system 100 through the variety of described interfaces 108.

### Example Process for Automation ROI Tracking

FIG. 2 shows an example process for automation ROI tracking, according to certain examples. For illustrative purposes, the process 200 is described with reference to implementations described above with respect to one or more examples described herein. Other implementations, however, are possible. In some aspects, the operations in FIG. 2 may be implemented in program code that is executed by one or more computing devices such as the computing system 100 of FIG. 1. In some aspects of the present disclosure, one or more operations shown in FIG. 2 may be omitted or performed in a different order. Similarly, additional operations not shown in FIG. 2 may be performed.

At block 202 the process 200 involves receiving a set of manual metrics corresponding to execution of a manual task. The manual metrics can be received for instance, via the request interface 108 wherein a user such as a product owner 122 enters in data related to the manual task. For instance, when the request interface 108 comprises a web-based interface, the user providing the inputs can input POST and DELETE methods to provide details related to the manual task. Details related to the manual task can include line of business, manual hours, customer data, and the like. The user may also input automation details linking the manual task to an automated process. Required information for automation detail input can include the title of the task to be automated, to provide for indexing, and additionally the automation type, indicating the language or environment that the automation is developed in. The automation type can be restricted to a set of environments, for instance, including Ansible DotNet, GoLang, Java, Python, and other coding environments.

Examples of manual metrics received can include line of business information, development information including developer teams creating the automation along with developer contact information customer teams including teams the automation is being developed for (which may or may not be the same as the developer team) along with customer team contact information, and manual hours indicating the hours required by manual or current automation of the process takes to execute.

At block 204 the process 200 involves receiving a request to execute an automation software. After the automation document has been created including automation details, a given automation software may be linked to the automation details document, allowing for comparison between a given manual task and the automation software. Then, a request may be fielded to execute the automation software, now linked to the automation details document. The request to execute the automation software may comprise an API call with any variety of format. In one example, the API call format can include a PATCH method, with a java script open notation format (“JSON”) body, including the automation title and job status (e.g., a Boolean value indicating the status of the job run where true indicates a successful run while false represents a failed run).

At block 206 the process 200 involves generating a set of automation metrics corresponding to an execution of the automation software. The set of automation metrics can be generated during the execution of the automation software and subsequently stored as automation details within the collection 114 for subsequent comparison and analysis with respect to the manual metrics.

Examples of generated automation metrics can include metadata associated with the automation software such as creation/modification date data and automation title data (e.g., to provide for database indexing). Automation metrics can further include the automation configuration, indicating the language or environment in which the automation software is developed (e.g., Python, Perl, Java and the like), success rate scores indicating the frequency of success or failure of the automation, and automation usage details such as an automation length indicating execution runtime and job inventory indicating the number of devices touched by the automation software during execution of the automation. Additional metrics may be generated according to various examples.

At block 208 the process 200 involves generating a set of comparison metrics based on comparing the set of manual metrics with the set of automation metrics. The comparison metrics indicate changes in performance and functionality between manual execution of a task, or previous automations of the task, and a new candidate automated software's execution of the task. A variety of comparison metrics can be included according to various examples. For instance, according to certain examples, the set of comparison metrics includes an hours saved metric and/or a devices affected metric. The hours saved metric can be generated based on comparing the manual metric representing manual hours required to complete the task compared against the execution runtime metric included in the set of generated automated metrics. The devices affected metric, also referred to as the job inventory can include data indicating the number of devices the automation software touched or otherwise interfaced with during the automation software's execution.

In some examples, generating the set of comparison metrics can account for additional costs of implementing the candidate automation software. For instance, the Automation ROI service 102 can identify a set of solution cost metrics associated with the automation software including development costs, ongoing maintenance costs, and licensing costs. The development cost can refer to the estimated effort expenditures of integrating the automation software into the manual environment (e.g., reconfiguring the automation software from one code base or output to another code base or output). The ongoing maintenance costs can refer to costs related to maintaining the automation software, such as by evaluating the projected end of life of the automation software or of the task itself, as well as other obsolescence planning; and the licensing costs can refer to associated fees with procuring and integrating the automation software into the system, provided the automation software is procured from a third party.

At block 210 the process 200 involves outputting the set of comparison metrics. Outputting the set of comparison metrics can include outputting a subset of the comparison metrics according to one or more interfaces. For instance, the ROI Tracker interface 118 may be configured to output cost-benefit analysis metrics related to implementing the automation service 110 to replace previous execution of the manual task. The ROI tracker interface 118 may have particular relevance to managing users 124 such as project managers evaluating whether to implement an automation service 110 from a cost-benefit perspective. Additionally or alternatively, the health tracker interface 120 may be configured to output a subset of the comparison metrics corresponding to network stability such as the number of devices affected by the automation service and network risks related to the automation service 110.

FIG. 3 shows an additional example process for automation ROI tracking, according to certain examples. Specifically FIG. 3 shows an example process by which the automation ROI tracking system can measure intangible benefits of implementing automation software to enable the completion of higher value work according to certain examples. For illustrative purposes, the process 300 is described with reference to implementations described above with respect to one or more examples described herein. Other implementations, however, are possible. In some aspects, the operations in FIG. 3 may be implemented in program code that is executed by one or more computing devices such as the computing system 100 of FIG. 1. In some aspects of the present disclosure, one or more operations shown in FIG. 3 may be omitted or performed in a different order. Similarly, additional operations not shown in FIG. 3 may be performed.

At block 302 the process 300 involves determining a cost saved metric based on an hours saved metric. Per block 208 of process 200, the hours saved metric can be determined based on comparing the manual metric representing manual hours required to complete the task compared against the execution runtime metric included in the set of generated automated metrics. To generate the cost saved metric, the hours saved metric may be compared against additional manual metrics, such as the customer data indicating the customer team the automation would be executed on behalf of. The cost saved metric can also account for additional costs of implementing the automation software, such as licensing costs, subscription costs, and maintenance costs of maintaining the implementation of the automation software.

At block 304 the process 300 involves determining a field occupancy metric based on a field value. The field value can include data indicating the recipients or customers who could benefit from automated execution of the previously manually executed task. For instance, the field value may indicate the team, along with head count, responsible for executing the manual task. Examples of filed values can include development teams such as Privacy teams, Security teams, Network teams, Client Interface team and the like. The field occupancy metric, based on the field value, can represent the current number of users and associated hours assigned to execution of the manual task. For instance, a greater field occupancy metric can be indicative of a lower number of users or developers assigned within a task field where a greater set of hours are expended. In such a way, the field occupancy metric can provide an alternative view of the benefits of automating software based on current encumbrances on execution of a given task within a field.

At block 306 the process 300 involves determining an opportunity cost metric based on the cost saved metric and the field occupancy metric. The opportunity cost metric can represent inefficiencies in current allocation resources to different tasks, such as fields and development teams under-assigned with team members given the projected costs saved with implementing a given automation software. A higher opportunity cost may correspond with a higher cost saved metric and higher field occupancy metric, indicating that valuable resources, such as team members, are over allocated to a given task that was determined (per block 208) to have a higher cost saved metric.

At determination 308 the process 300 involves determining whether the opportunity cost, determined per block 306, exceeds a cost threshold value. In response to determining the opportunity cost metric exceeds the cost threshold value, the process 300 proceeds to block 310 where the process involves generating a flag for output. The flag for output can include reconfiguring a given interface such as the ROI tracker interface 118, to automatically highlight, re-arrange, or otherwise modify the display of a given listed automated task to alert a user (e.g., managing user 124), to reprioritize or reallocate resources based on the determination.

### Example Processes for Interfacing With the Automation ROI System

FIG. 4 shows example processes for interfacing with the automation ROI tracking system, according to certain examples. For illustrative purposes, the processes 400, 410 is described with reference to implementations described above with respect to one or more examples described herein. Other implementations, however, are possible. In some aspects, the operations in FIG. 4 may be implemented in program code that is executed by one or more computing devices such as the computing system 100 of FIG. 1. In some aspects of the present disclosure, one or more operations shown in FIG. 4 may be omitted or performed in a different order. Similarly, additional operations not shown in FIG. 4 may be performed.

Process 400, illustrated by blocks 402-408 shows an example of operations of an input interface (e.g., request interface 108) where the input interface is configured to enforce flexible, extensible schema. The schema can allow for various formats of input data related to manual task such as the manual metrics to be input into the ROI automation service 102 while further ensuring necessary data for ROI tracking is also included within the manual metrics.

At block 402 the process 400 involves receiving a set of manual metrics corresponding to execution of a manual task. Block 402 is similar to block 202 of process 200, but further illustrates, according to some examples, specific procedures for how block 202 is performed, as defined by subsequent blocks 404-408

At block 404 the process 400 involves receiving a candidate entry. Also referred to as an intake request, the candidate entry can be a data format including a variety of field values either necessary or optional for subsequent storage as manual metrics and for further execution by the automation ROI service 102. The candidate entry may be received by user input to the request interface 108, where the request interface is communicatively coupled to a request reception service for intake analysis and entry validation.

At block 406 the process 400 involves validating one or more of a field value, task value, or hour value associated with the candidate entry. The field value, as described per block 304 can include data indicating the recipients or customers who could benefit from automated execution of the previously manually executed task. The task value can include data describing the manual task for automation or the corresponding software automation service, including the automation title, and automation type. The automation type may be a restricted entry with a provided list of software automation types, where users may need to submit additional requests through the request interface 108 for more software automation types to be provided and selectable via the interface. The hour value can include the hours that current manual or automated processes take to execute. Such values including the field value, task value, and hour value can be validated, per request reception service 104, to ensure that values are properly entered and non-null. Depending on the configuration, a combination of one or more of such values may be required for valid intake (e.g., a field value and hour value may be required, but not a task value, or any other combination of values).

At block 408 the process 400 involves storing the candidate entry as the set of manual metrics. On proper validation according to block 406, the request reception service 104 has ensured necessary information for generating the comparison metrics are recorded. At such a point, the ROI automation service 102 can link the execution of an automation service 110 to the manual metrics for creation of collection data 114 for storage and retrieval via the ROI database 112.

Process 410, illustrated by blocks 412-416 shows an example of operations of various output interfaces (e.g., ROI tracker interface 118 and health tracker interface 120) such interfaces are capable of tailoring ROI analyses for display according to the needs of various users. Such interfaces can provide visualized dashboards by pulling data from the ROI database 112.

At block 412 the process 410 involves receiving a request to output the set of comparison metrics and a user configuration associated with the request. The request to output the set of comparison metrics can include a request to output a subset of the comparison metrics or a specified request to display the set of comparison metrics via a specific display. The user configuration coupled to the request can include metadata associated with the request indicating the user issuing the request. For instance, the user configuration associated with the request may indicate that the user initiating the request is managing user 124 or a technical user 126. Moreover, the user configuration can include access permissions, where based on the user configuration may be granted or denied access to various metrics within the set of comparison metrics. Based on the request and the user configuration associated with the request, the process 410 can proceed to blocks 414 and 416.

At block 414 the process 410 involves outputting a first subset of the comparison metrics including the hours saved metric. The first subset of comparison metrics can be output, for instance via a first display interface such as the ROI tracker interface 118 for presentation to users such as managing users 124 including leadership team members, project managers and the like. Thus, the first display may be particularly configured to display metrics such as the hours saved metric, costs saved metric and other data from within the collection indicating an ROI. In some examples, access controls may be implemented to grant or deny access to the first display interface, such that non-enabled users lacking managing user credentials are denied access to the first subset of the comparison metrics reflective of ROI.

At block 416 the process 410 involves outputting, a second subset of the comparison metrics including a stability score of the network. The second subset of comparison metrics can be output, for instance via a second display interface such as health tracker interface 120 for presentation to users such as technical users 126 including developers, technicians and the like. The second display may be particularly configured to display metrics such as the drift metric, network stability score, criticality score and other data from within the collection indicating changes in stability due to implementation of automation software such as automation service 110. Further examples of network stability scores and metrics are described further with respect to FIG. 5. As with the first display interface, in some examples, access controls may be implemented to grant or deny access to the second display interface, such that non-enabled users lacking technical user credentials are denied access to the second subset of the comparison metrics reflective of network and infrastructural stability.

### Example Process for Automation Risk Monitoring

In some examples, the automation ROI tracking system can monitor not only the tangible benefits of reduction in hours spent on tasks based on candidate automation software but can also monitor and analyze improvements to infrastructural stability, improving risk profiles across multiple areas and services within a computing network. By monitoring stability (e.g., drift) across separate executions of manual tasks, and identifying the risks of instability for the manual task. the automation ROI tracking system thus provide technical improvements to network stability

FIG. 5 shows example process for determining network stability within automation ROI tracking system, according to certain examples. For illustrative purposes, the process 500 is described with reference to implementations described above with respect to one or more examples described herein. Other implementations, however, are possible. In some aspects, the operations in FIG. 5 may be implemented in program code that is executed by one or more computing devices such as the computing system 100 of FIG. 1. In some aspects of the present disclosure, one or more operations shown in FIG. 5 may be omitted or performed in a different order. Similarly, additional operations not shown in FIG. 5 may be performed.

At block 502, the process 500 involves generating a drift metric among a set of comparison metrics, the drift metric based on manual metrics and the devices affected metric. Drift generally refers to the risk of inconsistent execution of a manual task potentially leading to variations in both execution and outputs of the manual task. Implementation of automation software can reduce the risks of drift can be reduced by ensuring consistent execution of the task through automation. The automation ROI tracking system can monitor the return on investment of implementing the automation software by determining the drift associated with the execution of the manual task. For example, a drift metric can be generated based on the manual metrics and the devices affected metric.

At block 504, the process 500 involves determining a stability score of a network based on the drift metric. The stability score can represent the likelihood of drift, and the degree of preexisting and projected drift related to the manual task based on the drift metrics. The stability score can also represent instances where drift in execution of the candidate manual task, may exceed a threshold drift, where exceeding the threshold drift can be indicative of intolerable drift impairing network stability.

At block 506, the process 500 involves generating a criticality score based on the set of manual metrics and the devices affected metric. The criticality score can represent the significance of a given task with respect to network stability. For instance, a candidate task for automation including load balancers which configures 90% of devices across a network may be assigned a higher criticality score compared to a candidate task including router configuration for 5% of devices across the network.

At block 508, the process 500 involves determining a network risk profile based on the stability score and the criticality score. The network risk profile can represent the risks associated with implementing a given automation software in comparison with the risks of current manual execution of the corresponding task. Particularly, as described above, manual execution of a given task may be subject to drift, impairing the stability of the task over continuous execution of the task. The stability score, indicating the associated drift associated with a given manual task, can be compared against the criticality score, indicating the significance of the task as it relates to network stability

At determination 510, the process 500 involves evaluating whether the network risk profile exceeds a threshold risk score. In response to determining network risk profile exceeds a threshold risk value, the process 500 proceeds to block 512, where at block 512, the process involves generating an alert. An alert may be output across one or more interfaces and devices including interfaces 108, 118, and 120. Particularly, the alert can be output via the health tracker interface 120 with a display already configured to monitor and report the health of the network and the effects of implementing automation software within the network computing environment. In other examples, the process 500 can include prioritizing on a display interface, the list of tasks with network risk profiles. In other examples, in addition or alternatively to generating an alert at block 512, process 500 can include automatically implementing or integrating the automation software. For instance, if the network risk profile exceeds a heightened threshold risk score, indicative of significant network instability, the ROI automation service may respond by automatically implementing the automation software to reduce the identified network instability.

### Example Computing Environment for Automation ROI Tracking

Any suitable computing system or group of computing systems can be used for performing the operations described herein. For example, FIG. 6 shows a block diagram for an example computing environment capable of executing the described systems and methods, according to certain examples.

The depicted example of a computing system 602 includes one or more processors 606 communicatively coupled to one or more memory devices 604. The processor 606 executes computer-executable program code or accesses information stored in the memory device 604. Examples of processor 606 include a microprocessor, an application-specific integrated circuit (“ASIC”), a field-programmable gate array (“FPGA”), or other suitable processing device. The processor 606 can include any number of processing devices, including one.

The memory device 604 includes any suitable non-transitory computer readable medium for storing instructions including the ROI automation interface 622, display instructions 624, device monitor 626, and other dynamic objects 628 or other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 602 may also include a number of external or internal devices such as input or output devices. For example, the computing system 602 is shown with an input/output (“I/O”) interface 608 that can receive input from input devices or provide output to output devices. A bus 608 can also be included in the computing system 602. The bus 608 can communicatively couple one or more components of the computing system 602.

The computing system 602 executes program code that configures the processor 606 to perform one or more of the operations described above with respect to FIGS. 1-5. The program code includes operations related to, for example, receiving and ingesting data files, generating metadata associated with the data files, and determining access to the data files, or other suitable applications or memory structures that perform one or more operations described herein. The program code may be resident in the memory device 604 or any suitable non-transitory computer-readable medium and may be executed by the processor 606 or any other suitable processor. In some examples, the program code described above, including the ROI automation interface 622, display instructions 624, device monitor 626, and other dynamic objects 628 or received or determined values or data objects are stored in the memory device 604, as depicted in FIG. 6. In additional or alternative examples, one or more of the including the ROI automation interface 622, display instructions 624, device monitor 626, and other dynamic objects 628 or received or determined values or data objects described above are stored in one or more memory devices accessible via a data network, such as a memory device accessible via a cloud service.

The computing system 602 depicted in FIG. 6 also includes at least one network interface 612. The network interface 612 includes any device or group of devices suitable for establishing a wired or wireless data connection to one or more networks 614 such as viewing applications 620 including user interfaces. Non-limiting examples of the network interface 612 include an Ethernet network adapter, a modem, and/or the like. A remote communication service 618 is connected to the computing system 602 via network 614 and can perform some of the operations described herein including generating templates or receiving messaging data and applying the messaging data to a specified template. The computing system 602 is able to communicate with one or more of the remote communication service 618 and data repository 616. Data repository 616 can include multiple distinct data repository for retrieving and storing data across the network 614. For instance, data repository can include distributed file systems such as the ROI database 112 and additional repositories for retrieving various automation services 110.

### Advantages of Systems and Methods for Automation ROI Tracking

The described techniques for tracking the performance of automation software are rooted in computer technology, resolving issues arising from software automation and lack thereof. The described systems and methods provide techniques for monitoring the performance of automation software as implemented in a larger computing network to determine the return on investment of implementing the software, from both a network security perspective, and further from resource efficiency perspective (e.g., the value of assigning team members to a task versus determining to automate the task).

For instance, drift, referring to the gradual changes in network performance, behavior, and structure, can degrade network performance, such as by increasing latency and by resulting in configuration inconsistencies across a network. Certain causes of drift result from repeated manual execution of a given task, while automating the task can reduce intolerable drift. However, identifying which tasks should be prioritized to most efficiently reduce drift and thereby most efficiently improve network stability in of itself can be a complex task, given a system's inability to track such drift. The recited systems and methods resolve such issues by identifying and implementing software for automation based on network stability scores based on drift, thereby increasing the stability of the network.

The described systems and methods enable the elimination and/or reduction of repetitive manual operations by tracking the execution of an automation software, generating automation metrics based on the execution, and comparing those automation metrics with a set of manual metrics corresponding to manual execution of the same task. Such systems and methods can further increase the velocity of completed tasks by identifying the best candidate tasks for automation based on the generated comparison metrics. The generated comparison metrics can further be analyzed per an intuitive display portal including multiple interfaces and dashboards, each corresponding to different sets of users. Thus, the immediate and long term benefits of integrating various automation software can be visualized.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
receiving a set of manual metrics corresponding to execution of a manual task;
receiving a request to execute an automation software;
generating a set of automation metrics corresponding to an execution of the automation software;
generating a set of comparison metrics based on comparing the set of manual metrics with the set of automation metrics; and
outputting the set of comparison metrics.

2. The method of claim 1, further comprising:
in response to receiving the request to execute the automation software, identifying a set of solution cost metrics associated with the automation software and including a development cost, an ongoing maintenance cost, and a licensing cost; and
wherein generating the set of comparison metrics is based on the set of solution cost metrics.

3. The method of claim 1, wherein receiving the set of manual metrics comprises:
receiving a candidate entry;
validating one or more of a field value, task value, or hour value, associated with the candidate entry; and
storing the candidate entry as the set of manual metrics.

4. The method of claim 3, further comprising:
in response to determining an opportunity cost metric exceeds a cost threshold value, generating a flag for output;
wherein the opportunity cost metric is determined by steps comprising:
determining a costs saved metric based on an hours saved metric included within the set of comparison metrics;
determining a field occupancy metric based on the field value; and
determining the opportunity cost metric based on the cost saved metric and the field occupancy metric.

5. The method of claim 1, wherein the set of automation metrics includes a success rate score, an automation length metric and an automation configuration.

6. The method of claim 1, wherein outputting the set of comparison metrics comprises:
receiving a request to display the set of comparison metrics and a user configuration associated with the request;
based on the request and the user configuration associated with the request:
displaying, via a first display interface, a first subset of the set of comparison metrics including an hours saved metric included within the set of comparison metrics; or
displaying, via a second display interface, a second subset of the set of comparison metrics including a stability score of a network.

7. The method of claim 1, wherein the set of comparison metrics further includes a drift metric, the drift based on the set of manual metrics and a devices affected metric included within the set of comparison metrics, wherein the drift metric represents a likelihood of variation between separate executions of the manual task.

8. The method of claim 7, further comprising determining a network risk profile, the network risk profile based on:
determining a stability score of a network, the network coupled to the automation software and the manual task, based on the drift metric;
generating a criticality score based on the set of manual metrics and a devices affected metric included within the set of comparison metrics; and
generating the network risk profile based on the stability score and the criticality score.

9. The method of claim 8, the method further comprises, in response to determining the network risk profile exceeds a threshold risk value, generating an alert.

10. A system comprising:
one or more processors configured to:
receive a set of manual metrics corresponding to execution of a manual task;
receive a request to execute an automation software;
generate a set of automation metrics corresponding to an execution of the automation software;
generate a set of comparison metrics based on comparing the set of manual metrics with the set of automation metrics, ; and
output the set of comparison metrics.

11. The system of claim 10, wherein the one or more processors are further configured to:
in response to receiving the request to execute the automation software, identify a set of solution cost metrics associated with the automation software and including a development cost, an ongoing maintenance cost, and a licensing cost; and
wherein generating the set of comparison metrics is based on the set of solution cost metrics.

12. The system of claim 10, wherein receiving the set of manual metrics comprises:
receiving a candidate entry;
validating one or more of a field value, task value, or hour value, associated with the candidate entry; and
storing the candidate entry as the set of manual metrics.

13. The system of claim 12, wherein the one or more processors are further configured to:
in response to determining an opportunity cost metric exceeds a cost threshold value, generate a flag for output;
wherein the opportunity cost metric is determined by steps comprising:
determining a costs saved metric based on an hours saved metric included within the set of comparison metrics; and
determining a field occupancy metric based on the field value; and
determining the opportunity cost metric based on the cost saved metric and the field occupancy metric.

14. The system of claim 10, wherein the set of automation metrics includes a success rate score, an automation length metric and an automation configuration.

15. The system of claim 10, wherein outputting the set of comparison metrics comprises:
receiving a request to display the set of comparison metrics and a user configuration associated with the request;
based on the request and the user configuration associated with the request:
displaying, via a first display interface, a first subset of the set of comparison metrics including an hours saved metric included within the set of comparison metrics; or
displaying, via a second display interface, a second subset of the set of comparison metrics including a stability score of a network.

16. The system of claim 10, wherein the set of comparison metrics further includes a drift metric, the drift based on the set of manual metrics and a devices affected metric included within the set of comparison metrics, wherein the drift metric represents a likelihood of variation between separate executions of the manual task.

17. The system of claim 16, wherein the one or more processors are further configured to determine a stability score of a network, the network coupled to the automation software and the manual task, based on the drift metric; and
determine a criticality score based on the set of manual metrics and a devices affected metric included within the set of comparison metrics; and
wherein a network risk profile is generated based on the stability score and the criticality score.

18. The system of claim 17, wherein the one or more processors are further configured to, in response to determining the network risk profile exceeds a threshold risk value, generate an alert.

19. A non-transitory computer readable medium comprising instructions that, when executed by one or more processors, cause the one or more processors to:
receive a set of manual metrics corresponding to execution of a manual task;
receive a request to execute an automation software;
generate a set of automation metrics corresponding to an execution of the automation software;
generate a set of comparison metrics based on comparing the set of manual metrics with the set of automation metrics; and
output the set of comparison metrics.

20. The non-transitory computer readable medium of claim 19, wherein the instructions, when executed by one or more processors, cause the one or more processors to one or more processors to:
in response to receiving the request to execute the automation software, identify a set of solution cost metrics associated with the automation software and including a development cost, an ongoing maintenance cost, and a licensing cost; and
wherein generating the set of comparison metrics is based on the set of solution cost metrics.
